(19) United States
(12) Patent Application Publication
(10) Pub. No.: US 2022/0229841 A1
(43) Pub. Date: Jul. 21, 2022

(54) DATABASE STREAMING FOR AUTOMATED PROCESSES

(71) Applicant: ServiceNow, Inc., Santa Clara, CA (US)

(72) Inventors: Chandra Mouli Kharidehal, Hyderabad (IN); Joshua Timothy Nerius, Chicago, IL (US); Lakshmana Sambasiva Srinivas Kothuri, Hyderabad (IN); Mithun Kumar Reddy Gaddam, Hyderabad (IN)

(21) Appl. No.: 17/153,712

(22) Filed: Jan. 20, 2021

(51) Int. Cl. G06F 16/2455; G06F 16/2453; G06F 16/248; G06F 16/28; G06F 16/25

(52) U.S. Cl. CPC G06F 16/24568; G06F 16/24534; G06F 16/258; G06F 16/287; G06F 16/248

(57) ABSTRACT

A specification of data to be obtained from an external database during execution of an automated process configured using the process automation environment is received via a user interface of a process automation environment. An indication of the data to be obtained from the external database is provided to an intermediary server, wherein the intermediary server requests and obtains the data from the external database and sends a stream of the obtained data of the external database. The stream of the obtained data of the external database is received from the intermediary server. The obtained data of the external database is used in the automated process of the process automation environment.

### BACKGROUND OF THE INVENTION

Digitizing a workflow process can often increase the efficiency of performing the process. For example, converting a series of tasks to a digital and automated process can save a significant amount of time and resources. This can be especially true when the workflow process includes complex, repetitive, and/or many individual steps. Examples of these workflow processes can include approvals, notifications, and record operations, among others. When moved to a cloud service, the automated process can be managed from a single design environment. In many cases, the digitizing and automating of tasks in a single design environment provides a more consistent user experience.

### BRIEF DESCRIPTION OF THE DRAWINGS

Various embodiments of the invention are disclosed in the following detailed description and the accompanying drawings.

FIG. 1 is a block diagram illustrating an example of a process automation environment for creating and utilizing an automated process that streams data from an external database.

FIG. 2 is a block diagram illustrating an example of data streaming components of a process automation environment.

FIG. 3 is a flow chart illustrating an embodiment of a process for creating and utilizing an automated process that streams data from an external database.

FIG. 4 is a flow chart illustrating an embodiment of a process for configuring a streaming data step of an automated process.

FIG. 5 is a flow chart illustrating an embodiment of a process for a cloud instance to implement a database streaming step of an automated process.

FIG. 6 is a flow chart illustrating an embodiment of a process for an intermediary server to support the implementation of a database streaming step of an automated process.

FIG. 7 is a diagram illustrating an embodiment of a user interface for configuring a streaming data step of an automated process.

FIG. 8 is a diagram illustrating the process for implementing an external database as a streaming data source for an automated process.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Integration of database streaming for automated workflow processes is disclosed. Using the techniques disclosed herein, a process automation environment can support the streaming of data from external datastores, such as external databases. In various embodiments, as part of creating an automated process using a cloud-based process design environment, a data source step utilizing an external data source can be created with little to no programming experience. The interested data source can be specified, for example, by specifying a data source request such as a database SQL query along with data source connection parameters. When the automated process is executed, the requested data is retrieved as part of a step of the automated process as streaming data that can be iterated over. For example, each iteration step of the streamed data can process a converted object that corresponds to a transformed record or database query result element retrieved from an external database. In some embodiments, the objects are serialized into a human-readable text format that can be consumed by iterating over the data stream. In some embodiments, as part of the iteration step, the streamed data can further be stored in a cloud-based datastore, for example, as part of a migration process for migrating the data from the external database to a cloud-based datastore.

In some embodiments, the database streaming request is delegated to an intermediate server with the appropriate access to the external data source. The intermediate server requests the data by executing the data request and processes the request results as chunks of data. In some embodiments, each chunk is processed to serialize and convert the included database records or database query result elements into a converted object format that can be consumed by the automated process. The processed objects can be paginated into attachments that are written to a datastore of the cloud instance by the intermediate server. In some embodiments, the datastore is a memory, such as a scratch memory, of the cloud instance, a database of the cloud instance, or another appropriate datastore accessible by the cloud instance. Once the requested data is accessible at the cloud instance, the attachments are processed and provided to the automated process. The automated process can consume the streamed data by iterating over the transformed objects. In some embodiments, the transformation from records stored using an external database schema to the converted object format utilized by an automated process is performed by an automated transformation process and does not require a user to create or program a migration script. The process automation environment of the cloud instance facilitates the automatic conversion of external data to a format consumable by the automated process.

In some embodiments, a specification of data to be obtained from an external database during execution of an automated process configured using the process automation environment is received via a user interface of a process automation environment. For example, a user configures an external data source step for utilizing streaming data as an input for an automated process. The user interface is a graphical user interface that allows the automated process to be configured with little to no programming experience. In some embodiments, the specification of the data can include a database query, database configuration parameters such as database credentials, pre-processing steps for manipulating the requested data, and a transformation specification to automate the conversion of a database query result element to a converted object format used by the automated process. An indication of the data to be obtained from the external database is provided to an intermediary server. For example, a data stream request message is created and transmitted to an intermediary server to retrieve the requested data. The intermediary server requests and obtains the data from the external database and sends a stream of the obtained data of the external database. For example, in response to the data stream request message, the intermediary server executes the corresponding data request such as an SQL database query and provides the query results as a stream. In some embodiments, the intermediary server streams the data as chunks of paginated attachments after processing the database query results. The stream of the obtained data of the external database is received from the intermediary server. For example, the paginated attachments are processed and provided to an automated process as a stream of objects. The obtained data of the external database is used in the automated process of the process automation environment. For example, by iterating over the provided object data, the automated process can utilize the obtained data of the external database.

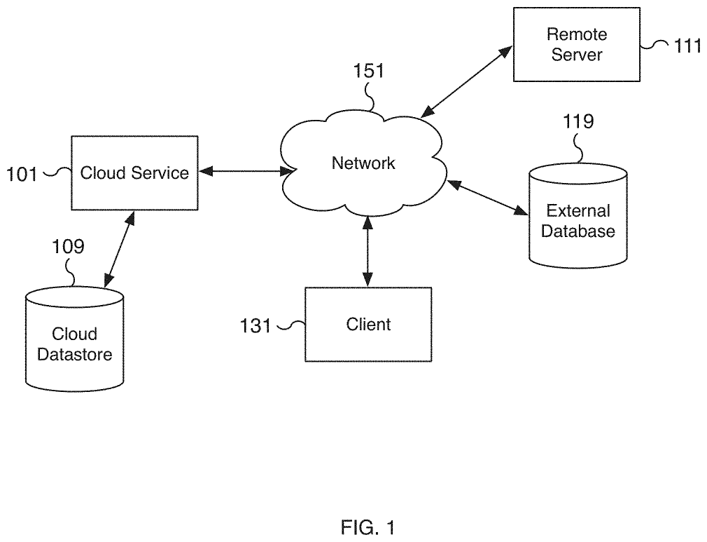

FIG. 1 is a block diagram illustrating an example of a process automation environment for creating and utilizing an automated process that streams data from an external database. In the example shown, client 131 accesses cloud-based services on cloud service 101 via network 151. The services offered by cloud service 101 can include an automation workflow design tool for creating, managing, and executing automated process workflows. Cloud service 101 is communicatively connected to cloud datastore 109 and utilizes cloud datastore 109 as both temporary and persistent data storage including for storing data associated with the automation workflow design tool and automated workflows. Network 151 can be a public or private network. In some embodiments, network 151 is a public network such as the Internet. Remote server 111 and external database 119 are also communicatively connected to network 151 and consequently cloud service 101 and client 131.

In some embodiments, remote server 111 is a customer server located within the customer's private network and is shielded from certain connections of network 151 via a firewall or another appropriate technique. Remote server 111 can be configured to disallow incoming network connections but maintains a private and secure connection with cloud service 101, for example, by initiating one or more outgoing connections from remote server 111 to cloud service 101. In some embodiments, external database 119 is an external customer database and can be used to store data using a custom schema. External database 119 can be located within a customer's private network and may even be located on the same private network as remote server 111 (not shown). In various embodiments, external database 119 does not allow database connections directly from cloud service 101 but does allow connections from remote server 111. In the example shown, an automation workflow design tool provided by cloud service 101 is utilized by client 131 to configure an automated process to process data stored in external database 119.

In some embodiments, remote server 111 is utilized by cloud service 101 as an intermediary server to access data from external database 119. For example, external database 119 can be shielded from cloud service 101 whereas remote server 111 can be configured with the required network permissions to create database connections to and execute queries on external database 119. To support data streaming of data from external database 119, cloud service 101 can utilize a private connection with remote server 111 to retrieve the interested data from external database 119, for example, for executing automated processes. In some embodiments, cloud datastore 109 is used as an intermediate storage for processing the streamed data and/or for migrating the data from external database 119. In some embodiments, cloud datastore 109 is also a configuration management database (CMDB) used by cloud service 101 for providing CMDB services related to automated process workflow solutions. Among other information, cloud datastore 109 can store configuration information related to configured automated processes and managed assets, such as related hardware and/or software configurations.

In some embodiments, network clients such as client 131 can access cloud service 101 to create a custom workflow that utilizes an external data source such as external database 119. The external data source can be configured as a stream data source utilized in one of the steps of the automated workflow process. Cloud service 101 supplies to a client, such as client 131, an interactive visual design tool. Utilizing the visual design tool, the external data source can be configured as a step of an automated workflow. In various embodiments, the visual design tool allows a user to create the automated workflow without requiring the user to write any software or programming code. In some embodiments, the created automated process can be executed via cloud service 101, and when executed, retrieves and processes data from the configured external data source. In some embodiments, client 131 is an example network client and can run on one of many different computing devices, including laptops, desktops, mobile devices, tablets, kiosks, smart televisions, etc. In various embodiments, client 131 is a network client such as a web browser for accessing the cloud-based services of cloud service 101.

Although single instances of some components have been shown to simplify the diagram, additional instances of any of the components shown in FIG. 1 may exist. For example, cloud service 101 may include one or more cloud server instances. Similarly, cloud datastore 109 may not be directly connected to cloud service 101 and/or may be replicated or distributed across multiple components, such as multiple cloud-based databases. As another example, client 131 is just one example of a potential client for accessing cloud service 101. Fewer or more clients can connect to cloud service 101. In some embodiments, components not shown in FIG. 1 may also exist.

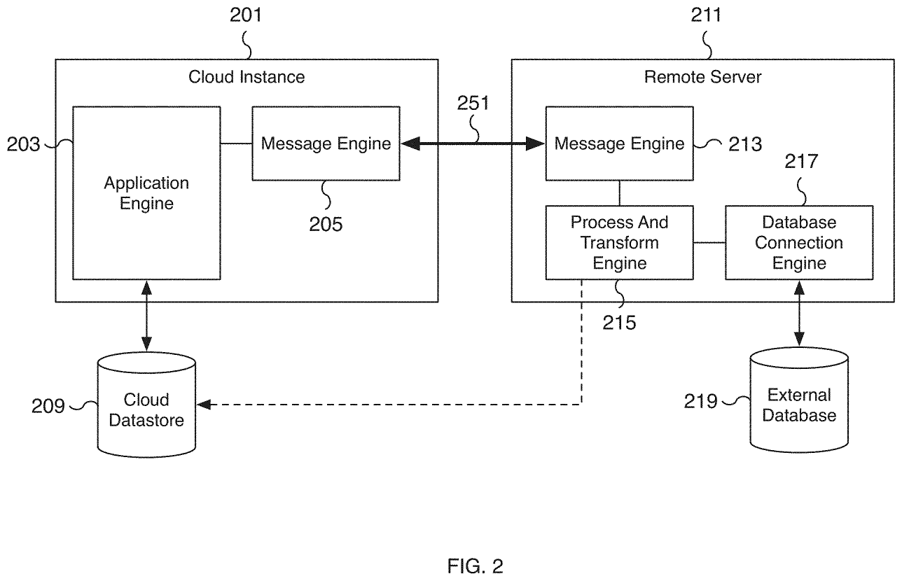

FIG. 2 is a block diagram illustrating an example of data streaming components of a process automation environment. Using the components shown in FIG. 2, data stored on a database external to cloud instance 201 (e.g., external database 219) is retrieved as streamed data to an automated process workflow. In the example shown, cloud instance 201 is communicatively connected to remote server 211 via network connection 251. Cloud instance 201 includes data streaming components application engine 203 and message engine 205, and remote server 211 includes data streaming components message engine 213, processing and transform engine 215, and database connection engine 217. Cloud datastore 209 is communicatively connected to cloud instance 201 and can be accessed by application engine 203 of cloud instance 201 as well as by processing and transform engine 215 of remote server 211. External database 219 is a database that can be accessed by database connection engine 217 of remote server 211. In the example shown, external database 219 cannot be directly accessed by any component of cloud instance 201. In some embodiments, cloud instance 201 is one or more servers of cloud service 101 of FIG. 1, cloud datastore 209 is cloud datastore 109 of FIG. 1, remote server 211 is remote server 111 of FIG. 1, external database 219 is external database 119 of FIG. 1, and network connection 251 is a network connection over network 151 of FIG. 1.

In some embodiments, the data streaming components of a process automation environment work together to provide data from an external database to an automated process via a streaming interface. For example, an automated process evaluated by application engine 203 includes a data streaming step to retrieve data from external database 219. When the data stream action step of a workflow is encountered, application engine 203 creates a data stream request message that is transmitted to remote server 211 over network connection 251 via message engines 205 and 213. In some embodiments, remote server 211 is configured to disallow incoming connections from cloud instance 201 and network connection 251 is established by remote server 211. For example, message engine 213 of remote server 211 establishes network connection 251 with message engine 205 of cloud instance 201 and listens for incoming messages, such as incoming data request messages. At remote server 211 and message engine 213, a data stream request message is received and includes a data request specification. The message is processed by process and transform engine 215. Process and transform engine 215 initiates the opening of a database connection to the requested external database, in this case external database 219, using database connection engine 217. A database query associated with the data stream request is executed by database connection engine 217 and the results are passed back to process and transform engine 215.

In some embodiments, the database query results from external database 219 are provided in chunks that are paginated into attachments by process and transform engine 215 for transmission to cloud instance 201. For example, process and transform engine 215 transforms the chunk results into serialized objects based on the received data request specification. The converted objects are compatible with the automated process being evaluated at application engine 203. In some embodiments, once an attachment of converted data is prepared, an attachment is written to cloud datastore 209 by process and transform engine 215 (shown by the dashed line). At cloud instance 201, application engine 203 processes the received attachments as streaming data. In various embodiments, application engine 203, in evaluating an automated process, iterates over the streaming data. For example, application engine 203 can iterate over each object in the streaming data. In some embodiments, a pre-processing step can be performed, such as a pre-processing script for transforming the received objects.

In some embodiments, as part of an automated process configuration process, the data streaming components of a process automation environment are used to automatically generate a transformation specification for converting records stored in external database 219 into objects compatible with an automated process executed at application engine 203. For example, in advance of executing an automated process, a test database query is executed using the request path described above. When the result of the sample query is received, the fields of the database query result are evaluated and a transformation specification from a database record or query result element to a converted object format is automatically generated and provided to application engine 203. A user can be presented with the automatically determined converted object format to confirm the validity of the format and is provided with the option to make customized modifications to the transformation specification. For example, a user can transform one or more fields as appropriate to convert the data into a more manageable or appropriate form. In some embodiments, an object schema may also be automatically created, for example, for writing the received objects into a cloud-base database such as cloud datastore 209.

Although specific components are shown in FIG. 2, fewer or additional components may exist. For example, in some embodiments, the data streaming components are distributed across multiple different cloud instances. For example, the application engine component used to configure an automated process may be different from the application engine component used to evaluate the automated process. Similarly, cloud datastore 209 may be one or more data stores such as an intermediate scratch memory for iterating over streaming data and one or more separate distributed cloud databases for storing migrated records. In various embodiments, FIG. 2 is limited to showing the key data streaming components and additional components not shown in FIG. 2 also exist.

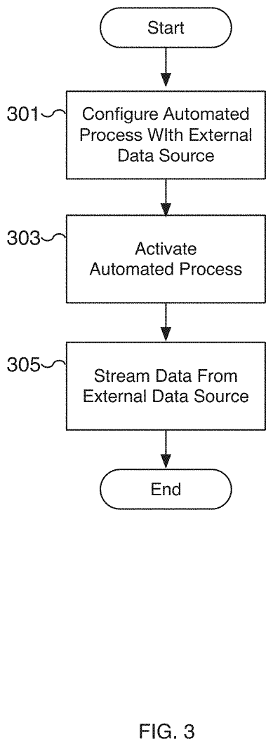

FIG. 3 is a flow chart illustrating an embodiment of a process for creating and utilizing an automated process that streams data from an external database. For example, using the process automation environment of FIG. 1, a user can configure a cloud-based automated process that streams data from an external database ordinarily inaccessible from a cloud instance. By streaming the requested data, a potentially arbitrarily large data set can be evaluated piecemeal, for example, one object at a time. Moreover, the ability to access an external database allows users to create automated workflows using data from third-party sites. In some embodiments, the cloud instance is a server of cloud service 101 of FIG. 1 and/or cloud instance 201 of FIG. 2, and the external database is external database 119 of FIG. 1 and/or external database 219 of FIG. 2. In some embodiments, the automated process is managed remotely via a client such as client 131 of FIG. 1.

At 301, an automated process with an external data source is configured. For example, a user using an interactive visual design tool configures an automated process. The configuration process requires little to no programming experience and the user is not required to write software or programming code. In some embodiments, the automated process is created by specifying a sequence of action and trigger steps. The actions and triggers can operate on input data such as data retrieved from an external database.

At 303, the automated process is activated. For example, the user activates the newly configured automated process that relies on data streamed from an external database. This allows the automated process to be evaluated by the cloud instance. In some embodiments, the process is scheduled to run at a predefined time and/or over pre-defined intervals.

At 305, data from the external data source is streamed. For example, as part of evaluating the automated process, data is retrieved from the external data source, such as an external database located in a customer's or a third party's internal network. The data can be retrieved via an intermediary server and is transformed from the database schema to a converted object format compatible with the automated process. In various embodiments, the streamed data is iterated over by one or more steps of the automated process, for example, by iterating over each transformed object in the streamed data. The workflow steps for streaming the data are typically just one of many action steps of the automated workflow. Once the data streaming step is complete, access to the external data source is no longer required.

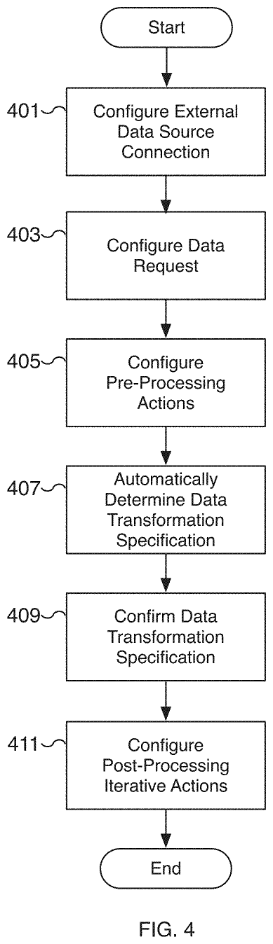

FIG. 4 is a flow chart illustrating an embodiment of a process for configuring a streaming data step of an automated process. Using the process of FIG. 4, a streaming data step can be configured for a workflow process using a low code or no code process automation environment. The configured step can specify an external data source, such as an external database, as an input data source for the workflow process. As data is retrieved, it can be processed as a stream of data objects. In some embodiments, the workflow steps iterate over the data stream to process streamed objects corresponding to transformed database records or database query results. In some embodiments, the process of FIG. 4 is performed at 301 of FIG. 3. In some embodiments, the process of FIG. 4 is performed by a client such as client 131 of FIG. 1 by accessing an interactive visual design tool of a cloud service such as cloud service 101 of FIG. 1. In some embodiments, the interactive visual design tool is implemented at least in part by application engine 203 of FIG. 2. The configured streaming data step can be stored in a cloud datastore such as cloud datastore 109 of FIG. 1 and/or cloud datastore 209 of FIG. 2.

At 401, an external data source connection is configured. For example, a user of a network client accesses an interactive visual design tool to configure an external data source connection to be used as the database source for a streaming data step of an automated process. The connection information can include the hostname, IP address, and/or another identifier of the external database along with additional connection information such as a database network port and database access credentials. For example, database credentials can include a username and login password. In some embodiments, the credentials utilize one of several supported credential frameworks. In various embodiments, the external data source connection is configured using a predefined connection referenced by a connection alias or name.

At 403, a data request is configured. For example, using an interactive visual design tool, a user configures a data request such as a database query. In some embodiments, the database query is specified as an SQL database query. The query can reference variables that are available in the context of the workflow process. For example, a global variable and/or a variable assigned from a previous step of the workflow process can be utilized in the specified SQL database query.

At 405, pre-processing actions are configured. For example, using an interactive visual design tool, a user configures optional pre-processing actions that can run before the streaming action sends the initial data request. For example, a pre-processing action can validate or set default values.

At 407, a data transformation specification is automatically determined. For example, a transformation specification to convert the data from the database format for database query result elements into a converted object format compatible with the automated process is performed. In some embodiments, the automated conversion process is performed by initiating a test database query and analyzing the returned query results. The results are mapped to a converted object format, for example, by identifying the fields of the query result and their corresponding data types. In some embodiments, an object schema is automatically generated along with a transformation specification. The object schema can be utilized for storing the streamed objects into a cloud datastore.

At 409, the data transformation specification is confirmed. For example, the data transformation specification automatically generated at 407 is presented to the user via an interactive visual design tool. The user can view the mapping of a database query result element to a converted object format and confirm that the transformation specification is correct. In some embodiments, the user can further modify the transformation specification, for example, to apply post-processing to specific fields and/or to modify a field's data type. The transformation can be applied to convert the retrieved data into a more manageable or appropriate form. For example, a user can modify the data transformation specification to concatenate two fields corresponding to a first name field and last name field into a single name field. As another example, a user can modify the data to convert binary data into a human-readable text format such as JavaScript Object Notation (JSON).

At 411, post-processing for iterative actions are configured. For example, using an interactive visual design tool, a user configures one or more post-processing actions to iterate over the retrieved object data. In some embodiments, the post-processing actions are subsequent steps that follow the streaming data step and are used to consume and process the streaming data. For example, an iterative action can be configured to write each retrieved object from the streaming data into a cloud database table. As another example, additional iterative actions can be used to create a new notification based on each retrieved object.

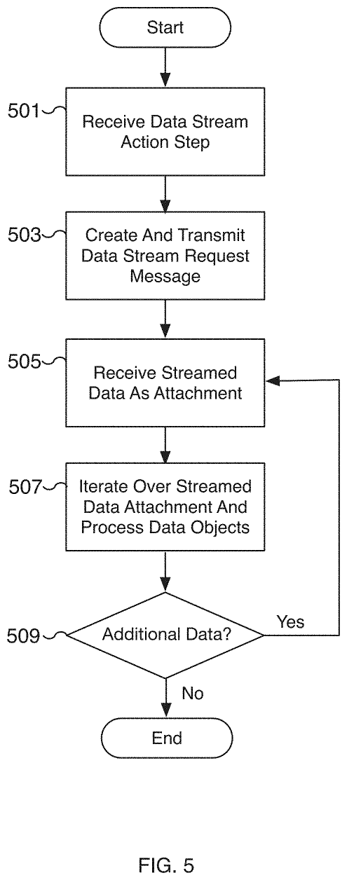

FIG. 5 is a flow chart illustrating an embodiment of a process for a cloud instance to implement a database streaming step of an automated process. Using the process of FIG. 5, a streaming data step referencing an external database is processed as part of an automated workflow. The external database is accessed via an intermediary server to retrieve the requested data, the external database query result elements are transformed into a converted object format, and the requested data transformed into a converted object format is provided to the automated process via a streaming interface. In some embodiments, the process of FIG. 5 is used to implement the streaming data step of an automated workflow configured using the process of FIG. 4. In some embodiments, the process of FIG. 5 is performed at 303 and/or 305 of FIG. 3. For example, database connections can be configured, established, and cached at 303 of FIG. 3 and the steps to retrieve and process the data requested can be performed at 305 of FIG. 3. In some embodiments, the process of FIG. 5 is performed by a cloud service such as cloud service 101 of FIG. 1 and/or by a cloud instance such as cloud instance 201 of FIG. 2. In particular, the process of FIG. 5 can be performed by the data streaming components of a cloud instance such as application engine 203, message engine 205, and/or cloud datastore 209 of FIG. 2. In some embodiments, the intermediary server is remote server 111 of FIG. 1 and/or remote server 211 of FIG. 2, and the external database is external database 119 of FIG. 1 and/or external database 219 of FIG. 2.

At 501, a data stream action step of a workflow is received. For example, an application engine such as application engine 203 receives a data stream action step. In some embodiments, the data stream action step specifies an external database connection, the data to request from the external database, pre-processing actions, and a data transformation specification, among other potential configuration settings. In some embodiments, the pre-processing actions are performed at 501. For example, pre-processing actions such as validation and initialization actions can be performed.

At 503, a data stream request message is created and transmitted. For example, a data stream request message is prepared that includes the required information for an intermediary server to request and process the requested data. In some embodiments, the message is prepared and transmitted using message engine 205 of FIG. 2 to the intermediary server where it is received by a corresponding message engine of the intermediary server and processed.

At 505, streamed data is received as an attachment. For example, streamed data corresponding to at least a portion of the requested data is provided to the cloud instance by the intermediary server. In some embodiments, the streamed data is written to a cloud datastore of the cloud instance, such as cloud datastore 109 of FIG. 1 and/or cloud datastore 209 of FIG. 2. In some embodiments, the cloud datastore is utilized as an intermediate memory store that temporarily stores or queues the received streaming data in anticipation of the data being processed at 507. The streamed data can be provided as an attachment that corresponds to a paginated result of the requested data. In various scenarios, the requested data can be arbitrarily large and is divided into paginated attachment results. At 505, a completed attachment is received for consumption by the automated process. In various embodiments, the received streaming data is formatted using a converted object format based on the transformation specification applied by the intermediate server.

At 507, the streamed data attachment is iterated over and data objects are processed. For example, an automated process is applied to consume the streamed database data as data objects. As the streamed data is iterated over by the steps of the automated process, the objects of the stream are consumed and can be processed one at a time. In some embodiments, the objects can be further transformed or modified as part of the workflow process. For example, the objects can be written to a cloud datastore as a migration step to duplicate (or transform) the data from the external database to a cloud-based database. In various embodiments, the automated process iterates over the third-party database data to create notifications, incident item reports, record operations, or perform other object-based actions.

At 509, a determination is made whether additional data exists. In the event additional data exists, processing loops back to step 505. In the event no additional data exists, processing completes.

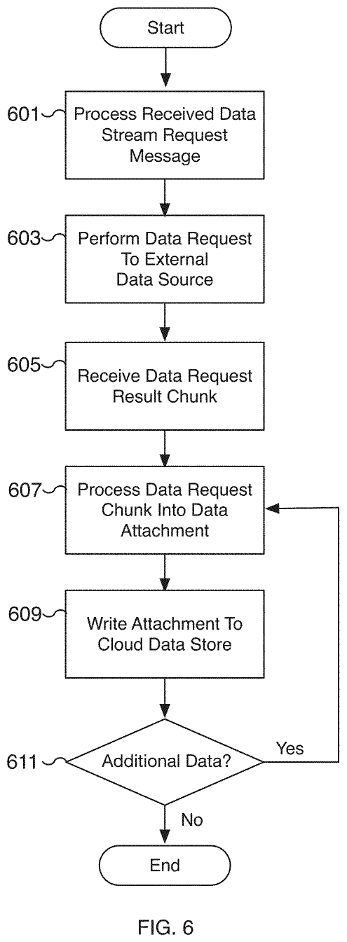

FIG. 6 is a flow chart illustrating an embodiment of a process for an intermediary server to support the implementation of a database streaming step of an automated process. Using the process of FIG. 6, an intermediary server can respond to a data stream request message from a cloud instance and provide the requested data in the requested format. In some embodiments, the process of FIG. 6 is performed in response to receiving a data stream request message transmitted by a cloud instance at 503 of FIG. 5. In some embodiments, transmitted results of the process of FIG. 6 are received by the same cloud instance at 505 of FIG. 5. In some embodiments, the process of FIG. 6 is performed at 303 and/or 305 of FIG. 3. For example, database connections can be configured, established, and cached at 303 of FIG. 3 and the steps to retrieve and process the data requested can be performed at 305 of FIG. 3. In some embodiments, the process of FIG. 6 is performed by a remote server such as remote server 111 of FIG. 1 and/or remote server 211 of FIG. 2. In particular, the process of FIG. 6 can be performed by the data streaming components of a remote server such as message engine 213, process and transform engine 215, and/or database connection engine 217 of FIG. 2. In some embodiments, the external database is external database 119 of FIG. 1 and/or external database 219 of FIG. 2.

At 601, a received data stream request message is processed. For example, a data stream request message from a cloud instance is received at a message engine of a remote server such as message engine 213 of FIG. 2. The message is decoded and processed by a process and transform engine such as process and transform engine 215 of FIG. 2. In various embodiments, the received message corresponds to a data stream action step of an automated process executing on the associated cloud instance. The message can specify an external database connection, the data to request from the external database, pre-processing actions, and a data transformation specification, among other potential configuration settings. In some embodiments, pre-processing actions can be performed at 601 on the intermediary server instead of, or in addition to, performing pre-processing actions on the cloud instance. For example, pre-processing actions such as validation and initialization actions based on the context of the remote server can be performed by a process and transform engine of the remote server.

At 603, a data request to an external data source is performed. For example, a database query is performed to retrieve the requested data from the specified external database. In some embodiments, a connection to the external database is established and the requested data is retrieved by executing a specified database query. In some embodiments, the connection is established, and an SQL query is executed using a database connection engine such as database connection engine 217 of FIG. 2 on an external database such as external database 219 of FIG. 2.

At 605, a data request result chunk is received. For example, in response to the data request performed at 603, the database query result is received in one or more chunks of query result data. In various embodiments, the query results are processed as each chunk of results is made available by the external database since the total amount of data returned by the data request can be arbitrarily large and consist of multiple result data chunks. As additional chunks are prepared by the external database, step 605 can be repeated to receive the additional data results.

At 607, the data request chunk is processed into a data attachment. In some embodiments, the data is processed by applying a transformation specification. In various embodiments, each data chunk corresponds to the at least a portion of the results of a database query. A transform specification is utilized to convert the data from a database format or schema to a converted object format compatible with the automated process of the cloud instance. In some embodiments, additional preprocessing steps may be performed prior to and/or during the conversion process. For example, two fields can be merged, the data type of a field can be modified, the data can be converted to a human-readable object text format, or another customized pre-processing modification or transformation can be performed.

In various embodiments, the data request chunk is processed into a data attachment. Since the data results can be arbitrarily long, the data request chunk is paginated into a data attachment. In various embodiments, the number of data request chunks used to create an attachment can depend on the data request chunk and attachment sizes. In some embodiments, one or more data request chunks are used to create a single attachment.

At 609, the data attachment is written to a cloud data store. For example, the data attachment is written to a cloud datastore of the cloud instance such as cloud datastore 209 of FIG. 2 of cloud instance 201 of FIG. 2 by a process and transform engine such as process and transform engine 215 of FIG. 2. In various embodiments, the process and transform engine of the remote server has access to write to storage of the cloud instance and streams the data to a datastore of the cloud instance directly rather than utilizing message engine 213, which can be appropriate as well.

At 611, a determination is made whether additional data exists. In the event additional data exists, processing loops back to step 607. In the event no additional data exists, processing completes.

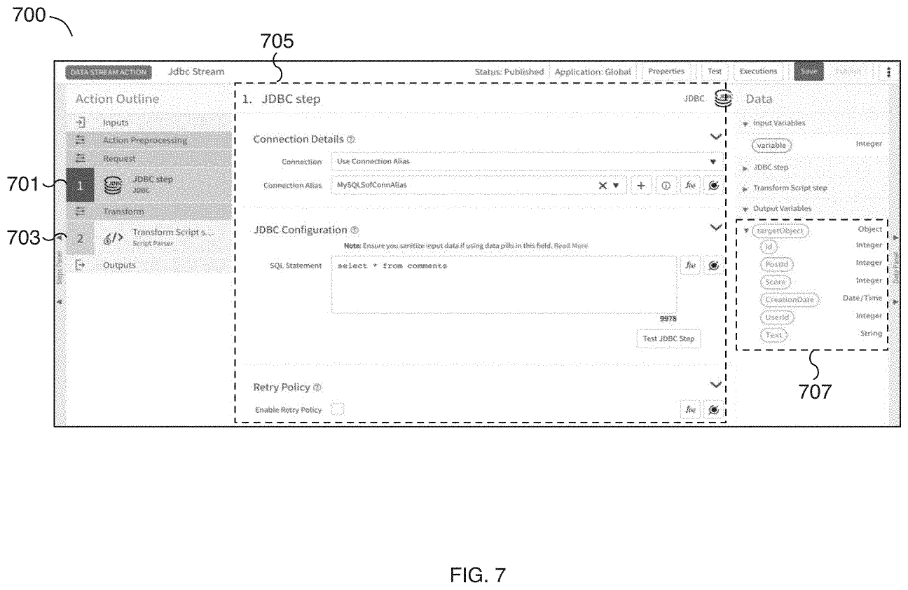

FIG. 7 is a diagram illustrating an embodiment of a user interface for configuring a streaming data step of an automated process. In the example shown, user interface 700 is an example embodiment of a user interface for configuring an external database for use as a streaming data source during an action step of an automated workflow. User interface 700 shows two step user interface labels, selected step label 701 for a streaming data step of the workflow process and step label 703 for a transform script step of the workflow process. User interface 700 also includes configuration section 705 and target object format section 707. In some embodiments, user interface 700 is a user interface view of an interactive visual design tool utilized by a user to perform at least a portion of the configuration performed at 301 of FIG. 3 and/or the process of FIG. 4. In some embodiments, user interface 700 is a user interface view of the interactive visual design tool provided by cloud service 101 of FIG. 1 and/or by a cloud instance such as cloud instance 201 of FIG. 1.

In some embodiments, the configuration settings shown in user interface 700 correspond to step label 701, a streaming data step of an automated workflow. As shown in user interface 700, step label 701 is labeled as step 1 and is a JDBC database streaming step. The JDBC database streaming step is used to configure an external database as a streaming data source using a Java Database Connectivity (JDBC) interface. Configuration settings of step 1 are shown in configuration section 705. As shown in the diagram, configuration section 705 includes a connection details section and a JDBC configuration. The connection details section allows the user to set up a database connection and can correspond to the settings configured at 401 of FIG. 4. The JDBC configuration section of configuration section 705 is used to configure an SQL statement used for requesting the database data. The “Test JDBC Step” button of configuration section 705 can be used to test the provided SQL statement with the provided connection details and/or to trigger the automatic determination of the data transformation specification performed at 407 of FIG. 4 as well as the confirmation of the data transformation specification performed at 409 of FIG. 4.

As shown in the example, the right portion of user interface 700 is a data section. The data window includes target object format section 707. Target object format section 707 shows the converted object format described by the transformation specification. For example, target object format section 707 specifies the six fields and corresponding data types of the target object. As shown in the example, the target object has an integer Id field, an integer PostId field, an integer Score field, a Date/Time CreationDate field, an integer UserId field, and a String Test field. In various embodiments, the displayed converted object format of target object format section 707 corresponds to the data transformation specification automatically determined at 407 of FIG. 4 and/or the data transformation specification confirmed at 409 of FIG. 4. In various embodiments, the database streaming step is configured to allow the streamed data to be iterated over by processing objects described by target object format section 707. In some embodiments, step label 703 corresponds to an iteration action step (not shown) for processing the streamed data from the external database as target objects.

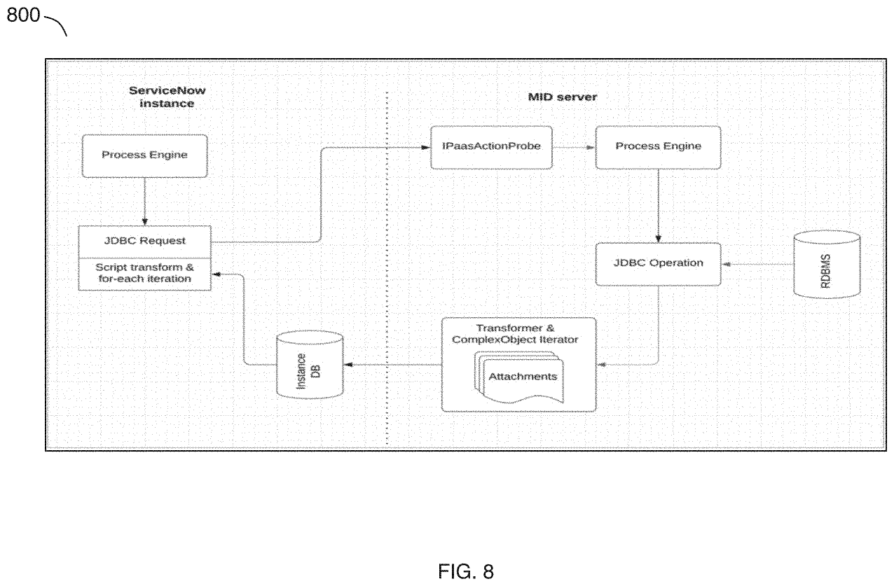

FIG. 8 is a diagram illustrating the process for implementing an external database as a streaming data source for an automated process. In the example shown, diagram 800 illustrates the interactions of different components of a process automation environment. The left half of diagram 800 labeled as ServiceNow instance corresponds to a cloud instance and its cloud datastore. The right half of diagram 800 labeled as MID server corresponds to a remote server and its external database. In some embodiments, the left half of diagram 800 corresponds to cloud service 101 and cloud datastore 109 of FIG. 1 and/or cloud instance 201 and cloud datastore 209 of FIG. 2, and the right half of diagram 800 corresponds to remote server 111 and external database 119 of FIG. 1 and/or remote server 211 and external database 219 of FIG. 2.

In some embodiments, the Process Engine and Script transform and for-each iteration components of the ServiceNow instance of diagram 800 correspond to application engine 203 of FIG. 2 of a cloud instance and the Process Engine and the Transformer and ComplexObject Iterator components of the Mid server of diagram 800 correspond to process and transform engine 215 of FIG. 2 of a remote server. In some embodiments, the JDBC Request component of diagram 800 is processed by message engine 205 of a cloud instance and the IPaasActionProbe component of diagram 800 is processed by message engine 213 of the remote server. In various embodiments, Instance DB datastore of diagram 800 is cloud datastore 209 of FIG. 2 and RDBMS datastore of diagram 800 is external database 219 of FIG. 2.

In the example shown, the arrows between the components of diagram 800 correspond to interactions performed for implementing an external database as a streaming data source. The interactions performed by the left half of diagram 800 correspond to one or more steps of the process of FIG. 5 and the interactions performed by the right half of diagram 800 correspond to one or more steps of the process of FIG. 6. As shown in diagram 800, the interaction starts at the Process Engine component of the ServiceNow instance as it processes a data stream action step by initiating a database streaming request. The JDBC Request component communicates to the MID server via the IPassActionProbe component. The MID server processes the communicated database streaming request using the Process Engine component of the MID server and relies on the JDBC Operation component to communicate with and obtain the requested data from the RDBMS datastore. The RDBMS datastore provides the requested data via the JDBC Operation component to the Transformer and ComplexObject Iterator component of the MID server where it is processed into attachments. The processing includes applying a transformation specification to convert the data from a database format to a converted object format compatible with the ServiceNow workflow process. The completed attachments are written to the Instance DB datastore of the ServiceNow instance where the objects included in the attachments are iterated over using the Script transform and for-each iteration component of the ServiceNow instance.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving via a user interface of a process automation environment, a specification of data to be obtained from an external database during execution of an automated process configured using the process automation environment, wherein the user interface is associated with an interactive visual design tool used to specify a sequence of action and trigger steps to create a desired customized workflow of the automated process;
indicating to an intermediary server the data to be obtained from the external database, wherein the intermediary server requests and obtains the data from the external database and sends a stream of the obtained data of the external database;
receiving from the intermediary server the stream of the obtained data of the external database; and
using the obtained data of the external database in the automated process of the process automation environment including by performing at least a portion of the sequence of action and trigger steps of the created customized workflow on streamed items of the obtained data of the external database.

2. The method of claim 1, wherein the specification of the data to be obtained from the external database includes a database query.

3. The method of claim 1, wherein the specification of the data to be obtained from the external database includes a transformation specification to convert a database query result element to a converted object.

4. The method of claim 3, wherein the transformation specification is associated with merging two fields of the database query result element into a single field of the converted object.

5. The method of claim 1, wherein using the obtained data of the external database in the automated process of the process automation environment includes iterating over a plurality of converted objects encoded in the stream of the obtained data of the external database.

6. The method of claim 5, further comprising converting for each converted object of the plurality of converted objects encoded in the stream of the obtained data into a human-readable text format.

7. The method of claim 5, further comprising storing the plurality of converted objects of the stream of the obtained data in a local data storage.

8. The method of claim 1, wherein the stream of the obtained data of the external database is received as one or more paginated attachments.

9. The method of claim 1, further comprising:
executing a database query;
receiving a database query result of the executed database query; and
automatically determining a converted object format from one or more fields of the database query result.

10. The method of claim 9, further comprising generating a converted object schema for the obtained data of the external database.

11. A system, comprising:
one or more processors; and
a memory coupled to the one or more processors, wherein the memory is configured to provide the one or more processors with instructions which when executed cause the one or more processors to:
receive via a user interface of a process automation environment, a specification of data to be obtained from an external database during execution of an automated process configured using the process automation environment, wherein the user interface is associated with an interactive visual design tool used to specify a sequence of action and trigger steps to create a desired customized workflow of the automated process;
indicate to an intermediary server the data to be obtained from the external database, wherein the intermediary server requests and obtains the data from the external database and sends a stream of the obtained data of the external database;
receive from the intermediary server the stream of the obtained data of the external database; and
use the obtained data of the external database in the automated process of the process automation environment including by performing at least a portion of the sequence of action and trigger steps of the created customized workflow on streamed items of the obtained data of the external database.

12. The system of claim 11, wherein the specification of the data to be obtained from the external database includes a database query.

13. The system of claim 11, wherein the specification of the data to be obtained from the external database includes a transformation specification to convert a database query result element to a converted object.

14. The system of claim 13, wherein the transformation specification is associated with merging two fields of the database query result element into a single field of the converted object.

15. The system of claim 11, wherein using the obtained data of the external database in the automated process of the process automation environment includes iterating over a plurality of converted objects encoded in the stream of the obtained data of the external database.

16. The system of claim 15, wherein the memory is further configured to provide the one or more processors with instructions which when executed cause the one or more processors to:
convert for each converted object of the plurality of converted objects encoded in the stream of the obtained data into a human-readable text format.

17. The system of claim 15, wherein the memory is further configured to provide the one or more processors with instructions which when executed cause the one or more processors to:
store the plurality of converted objects of the stream of the obtained data in a local data storage.

18. The system of claim 11, wherein the stream of the obtained data of the external database is received as one or more paginated attachments.

19. The system of claim 11, wherein the memory is further configured to provide the one or more processors with instructions which when executed cause the one or more processors to:
execute a database query;
receive a database query result of the executed database query;
automatically determine a converted object format from one or more fields of the database query result; and
generate a converted object schema for the obtained data of the external database.

20. A computer program product, the computer program product being embodied in a non-transitory computer readable storage medium and comprising computer instructions for:
receiving via a user interface of a process automation environment, a specification of data to be obtained from an external database during execution of an automated process configured using the process automation environment, wherein the user interface is associated with an interactive visual design tool used to specify a sequence of action and trigger steps to create a desired customized workflow of the automated process;
indicating to an intermediary server the data to be obtained from the external database, wherein the intermediary server requests and obtains the data from the external database and sends a stream of the obtained data of the external database;
receiving from the intermediary server the stream of the obtained data of the external database; and
using the obtained data of the external database in the automated process of the process automation environment including by performing at least a portion of the sequence of action and trigger steps of the created customized workflow on streamed items of the obtained data of the external database.
